(19) United States
(12) Patent Application Publication
(10) Pub. No.: US 2024/0257275 A1
(43) Pub. Date: Aug. 1, 2024

(54) METHOD FOR DETERMINING A RANKING OF TREATMENT PARAMETERS (SUCH AS CROP PROTECTION PRODUCTS) FOR TREATING AN AGRICULTURAL FIELD VIA AN EFFICACY ADJUSTMENT MODEL BASED ON GENETIC DATA

(71) Applicant: BASF AGRO TRADEMARKS GMBH, Ludwigshafen (DE)

(72) Inventors: Holger HOFFMANN, Köln (DE); Dario MASSA, Limburgerhof (DE)

(21) Appl. No.: 18/289,659

(22) PCT Filed: May 18, 2022
(86) PCT No.: PCT/EP2022/063454

§ 371 Date: Nov. 6, 2023

(30) Foreign Application Priority Data
May 19, 2021 (EP) 21174711.8

(51) Int. Cl. G06Q 50/02; A01B 79/00; A01C 21/00; A01M 7/00; G06Q 10/06

(52) U.S. Cl. CPC G06Q 50/02; G06Q 10/06; A01B 79/005; A01C 21/007; A01M 7/0089

(57) ABSTRACT

A computer-implemented method for generating a control file usable for controlling an agricultural equipment based on at least one treatment parameter, comprising the following steps: (step 1) (110) providing genetic measurement data (40) of at least one organism which existed or is existing or is expected to exist in the agricultural field, (step 2) (120) providing treatment parameter data (42) for at least two treatment parameters capable of targeting the at least one organism, (step 3) (130) based on the treatment parameter data (42), providing first level efficacy data (44) comprising efficacies (“first level efficacies”) of the at least two treatment parameters relating to the at least one organism on a first level of the taxonomic rank, (step 4) (140) based on the treatment parameter data (42) and the first level efficacy data (44), determining a first ranking (46) of the at least two treatment parameters, (step 5) (150) providing an efficacy adjustment model (50), (step 6) (160) by modifying the first level efficacy data (44) based on the genetic measurement data (40) and the treatment parameter data (42) via the efficacy adjustment model (50), obtaining second level efficacy data (52) comprising efficacies (“second level efficacies”) of the at least two treatment parameters relating to the at least one organism on a second level of the taxonomic rank being below the first level of the taxonomic rank, (step 7) (170) based on the treatment parameter data (42) and the second level efficacy data (52), determining a second ranking (54) of the at least two treatment parameters. (step 8) (180) outputting the highest ranked or user-selected treatment parameter as a control file usable for controlling an agricultural equipment

### FIELD OF THE INVENTION

The present invention relates to a computer-implemented method for determining a ranking of treatment parameters based on the genetic measurement data of at least one organism in the agricultural field, a data processing system comprising means for carrying out such computer-implemented method, the use of the highest ranked treatment parameter for controlling an agricultural equipment, and the use of the highest ranked treatment parameters for treating an agricultural field.

### BACKGROUND OF THE INVENTION

In practice, the farmer or user often faces the challenge that he/she does not know the exact genetic information (e.g. mutation, gene shifting, epigenetic change) of a harmful organism, a beneficial organism or an agricultural crop species, but nevertheless has to make a decision on the time window, method, product or does rate he/she would apply for controlling the harmful organism and protecting the beneficial organism or the agricultural crop species. This may lead to the problem that the product selected by the farmer or user is inappropriate or inefficient for controlling the specific genetic variant (mutation, gene shifting variant, or epigenetic variant) of the harmful organism in his/her agricultural field, which might lead to a further spread of the harmful organism and later on to severe yield losses. On the other hand, treatment devices which are operated fully or partially autonomously need to be provided with the most appropriate and/or optimal control file usable for controlling an agricultural equipment to treat harmful organisms and to protect the beneficial organisms or the agricultural crop species, considering the appearance of diverse resistant harmful organisms.

Several methods to determine a ranking of treatment parameters such as crop protection products without usage of genetic data are known, for example disclosed in the patent application WO2021/009135.

Several methods to determine the genetic information of an organism are known, inter alia the nanopore sequencing technology as for example disclosed in the patent application WO2019/149626.

In view of the above problem and challenge, it was found that there is a need to improve and simplify the decision process of the farmer or user.

### SUMMARY OF THE INVENTION

In view of the above, it is an object of the present invention to provide a computer-implemented method for determining a ranking of treatment parameters based on the genetic data of at least one organism in the agricultural field, which can be easily applied by a farmer or user. It is also an object of the present invention to provide a computer-implemented method for determining a ranking of treatment parameters based on the genetic data of at least one organism in the agricultural field, which supports fast and efficient decision-making for a farmer or user regarding the treatment of an agricultural field. It is also an object of the present invention to provide a computer-implemented method for determining a ranking of treatment parameters based on the genetic data of at least one organism in the agricultural field, which enables the recognition and quantification of resistances against certain crop protection products. It is also an object of the present invention to provide a computer-implemented method to improve the control of harmful organisms on the agricultural field. It is also an object of the present invention to provide a computer-implemented method to improve the protection or usage of beneficial organisms on the agricultural field. It is also an object of the present invention to provide a computer-implemented method to improve the yield or biomass or nutrient content or crop quality of agricultural crop plants grown on the agricultural field. It is also an object of the present invention to provide a computer-implemented method useful for the quality control regarding past or earlier treatments.

The objects of the present invention are solved with the subject matter of the independent claims, wherein further embodiments are incorporated in the dependent claims. It should be noted that the following described aspects and examples of the invention apply for the method as well as for the data processing system, the computer program product and the computer-readable storage medium.

According to the first aspect of the present invention, the present invention relates to a computer-implemented method for determining a ranking of at least two treatment parameters selected from the group consisting of:
a) at least one time window for a treatment in an agricultural field,
b) at least one method for a treatment in an agricultural field,
c) at least one product for a treatment in an agricultural field,
d) at least one dose rate for a treatment in an agricultural field, and
e) at least one treatment schedule for a treatment in an agricultural field comprising at least one method or product and a time window for applying the at least one method or product in the agricultural field,
comprising the following steps:
(step 1) (110) providing genetic measurement data (40) of at least one organism which existed or is existing or is expected to exist in the agricultural field,
(step 2) (120) providing treatment parameter data (42) for at least two treatment parameters capable of targeting the at least one organism,
(step 3) (130) based on the treatment parameter data (42), providing first level efficacy data (44) comprising efficacies (“first level efficacies”) of the at least two treatment parameters relating to the at least one organism on a first level of the taxonomic rank,
(step 4) (140) based on the treatment parameter data (42) and the first level efficacy data (44), determining a first ranking (46) of the at least two treatment parameters,
(step 5) (150) providing an efficacy adjustment model (50),
(step 6) (160) by modifying the first level efficacy data (44) based on the genetic measurement data (40) and the treatment parameter data (42) via the efficacy adjustment model (50), obtaining second level efficacy data (52) comprising efficacies (“second level efficacies”) of the at least two treatment parameters relating to the at least one organism on a second level of the taxonomic rank being below the first level of the taxonomic rank,
(step 7) (170) based on the treatment parameter data (42) and the second level efficacy data (52), determining a second ranking (54) of the at least two treatment parameters.

According to a further aspect of the present invention, the present invention relates to a computer-implemented method for generating a control file usable for controlling an agricultural equipment based on at least one treatment parameter selected from the group consisting of:
a) at least one time window for a treatment in an agricultural field,
b) at least one method for a treatment in an agricultural field,
c) at least one product for a treatment in an agricultural field,
d) at least one dose rate for a treatment in an agricultural field, and
e) at least one treatment schedule for a treatment in an agricultural field comprising at least one method or product and a time window for applying the at least one method or product in the agricultural field,
comprising the following steps:
(step 1) (110) providing genetic measurement data (40) of at least one organism which existed or is existing or is expected to exist in the agricultural field,
(step 2) (120) providing treatment parameter data (42) for at least two treatment parameters capable of targeting the at least one organism,
(step 3) (130) based on the treatment parameter data (42), providing first level efficacy data (44) comprising efficacies (“first level efficacies”) of the at least two treatment parameters relating to the at least one organism on a first level of the taxonomic rank,
(step 4) (140) based on the treatment parameter data (42) and the first level efficacy data (44), determining a first ranking (46) of the at least two treatment parameters,
(step 5) (150) providing an efficacy adjustment model (50),
(step 6) (160) by modifying the first level efficacy data (44) based on the genetic measurement data (40) and the treatment parameter data (42) via the efficacy adjustment model (50), obtaining second level efficacy data (52) comprising efficacies (“second level efficacies”) of the at least two treatment parameters relating to the at least one organism on a second level of the taxonomic rank being below the first level of the taxonomic rank,
(step 7) (170) based on the treatment parameter data (42) and the second level efficacy data (52), determining a second ranking (54) of the at least two treatment parameters,
(step 8) (180) outputting the highest ranked or user-selected treatment parameter as a control file usable for controlling an agricultural equipment.

According to a preferred embodiment of the present invention, obtaining of second level efficacy data (52) comprises the following steps:
(step 6a) (162) based on the genetic measurement data (40) and the treatment parameter da-ta (42), determining the type of genetics-specific response (56) of the at least one organism via the efficacy adjustment model (50),
(step 6b) (164) based on the type of genetics-specific response (56), modifying the first level efficacy data (44) via the efficacy adjustment model (50),
(step 6c) (166) outputting the modified first level efficacy data as second level efficacy data (52).

According to a further preferred embodiment of the present invention, the obtaining of second level efficacy data (52) comprises the following steps:
(step 6a) (162) based on the genetic measurement data (40) and the treatment parameter da-ta (42), assigning the type of genetics-specific response (56) of the at least one organism via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response,
(step 6b) (164) wherein in case of type 1 response (58), the first level efficacy data (44) are modified via the efficacy adjustment model (50) in a way that first level efficacies are reduced,
wherein in case of type 2 response (60), the first level efficacy data (44) are modi-fied via the efficacy adjustment model (50) in a way that that first level efficacies are reduced but reduced in a lower level compared to the case of type 1 response (58), wherein in case of type 3 response (62), the first level efficacy data (44) are modi-fied via the efficacy adjustment model (50) in a way that these data are vali-dated and/or remain unchanged,
(step 6c) (166) outputting the modified first level efficacy data as second level efficacy data (52).

According to a further preferred embodiment of the present invention, the obtaining of second level efficacy data comprises the following steps:
(step 6a) (162) based on the genetic measurement data (40) and the treatment parameter da-ta (42), assigning the type of genetics-specific response (56) of the at least one organism via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response,
(step 6b) (164) wherein in case of type 1 response (58), the first level efficacy data (44) are modified via the efficacy adjustment model (50) in a way that first level efficacies are set to zero,
wherein in case of type 2 response (60), the first level efficacy data (44) are modi-fied via the efficacy adjustment model (50) in a way that that first level efficacies are reduced but not set to zero—preferably reduced to 3% to 90% of their original level, more preferably reduced to 7 to 70% of their original level, most preferably reduced to 10% to 50% of their original level, particularly reduced to 15% to 40% of their original level—,
wherein in case of type 3 response (62), the first level efficacy data (44) are modi-fied via the efficacy adjustment model (50) in a way that these data are vali-dated and/or remain unchanged,
(step 6c) (166) outputting the modified first level efficacy data as second level efficacy data (52).

According to a further preferred embodiment of the present invention, the obtaining of second level efficacy data comprises the following steps:
(step 6a) (162) based on the genetic measurement data (40) and the treatment parameter data (42), assigning the type of genetics-specific response (56) of the at least one organism via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response,
(step 6b) (164) wherein in case of type 1 response (58), the first level efficacy data (44) are modified via the efficacy adjustment model (50) in a way that first level efficacies are reduced in such a way that all other treatment parameters targeting the at least one organism but not being affected by this type 1 response (58) are ranked higher than the affected treatment parameters,
wherein in case of type 2 response (60), the first level efficacy data (44) are modi-fied via the efficacy adjustment model (50) in a way that that first level efficacies are reduced in such a way that all other treatment parameters targeting the at least one organism but not being affected by this type 2 response (60) are ranked higher than the affected treatment parameters,
wherein in case of type 3 response (62), the first level efficacy data (44) are modi-fied via the efficacy adjustment model (50) in a way that these data are vali-dated and/or remain unchanged,
(step 6c) (166) outputting the modified first level efficacy data as second level efficacy data (52).

According to a further preferred embodiment of the present invention, the at least two treatment parameters are products for treatment in an agricultural field, and the obtaining of second level efficacy data comprises the following steps:
(step 6a) (162) based on the genetic measurement data (40) and product data (42), assigning the type of genetics-specific response (56) of the at least one organism via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response,
(step 6b) (164) wherein in case of type 1 response (58), the first level efficacy data (44) are modified via the efficacy adjustment model (50) in a way that first level efficacies are reduced in such a way that all other products (including product mixtures such as tank mixes) targeting the at least one organism but not being affected by this type 1 response (58)—including preferably all other products or product mixtures comprising at least one active ingredient with another mode-of-action, or all other non-chemical products—are ranked higher than the affected treatment parameters,
wherein in case of type 2 response (60), the first level efficacy data (44) are modi-fied via the efficacy adjustment model (50) in a way that that first level efficacies are reduced in such a way that all other products products (including product mixtures such as tank mixes)—including all other products or product mixtures comprising at least another active ingredient, or all other non-chemical products—targeting the at least one organism but not being affected by this type 2 response (60) are ranked higher than the affected treatment parameters,
wherein in case of type 3 response (62), the first level efficacy data (44) are modi-fied via the efficacy adjustment model (50) in a way that these data are vali-dated and/or remain unchanged,
(step 6c) (166) outputting the modified first level efficacy data as second level efficacy data (52).

For the assigning of the type of genetics-specific response (56) of the at least one organism, an automatic database search may be performed or initiated, for example a database search in resistance databases such as http://weedscience.org/, HRAC, FRAC or IRAC resistance tables or other scientific databases or product databases comprising resistance data, and the assigning may be conducted based on the result of such database searches.

For reducing the first level efficacies in case of type 1 response (58) or in case of type 2 response (60), an automatic database search may be performed or initiated, for example a database search in resistance databases such as http://weedscience.org/, HRAC, FRAC or IRAC resistance tables or other scientific databases or product databases comprising resistance data, and the reducing may be conducted based on the result of such database searches.

According to a further preferred embodiment of the present invention, determining a first ranking of treatment parameter can be additionally based on
(A) agricultural crop data comprising (aa) information about an agricultural crop species grown, sown, planned to be grown, or planned to be sown in the agricultural field, and/or (bb) information about the growth stage of such agricultural crop, and/or
(B) weather and/or geographical data relating to the location of the agricultural field, and/or
(C) historic treatment data relating to treatments conducted in the agricultural field in the past, wherein the data (A), (B), and/or (C) are provided before the step of determining a first ranking.

According to a further preferred embodiment of the present invention, determining a second ranking of treatment parameter can be additionally based on
(A) agricultural crop data comprising (aa) information about an agricultural crop species grown, sown, planned to be grown, or planned to be sown in the agricultural field, and/or (bb) information about the growth stage of such agricultural crop, and/or
(B) weather and/or geographical data relating to the location of the agricultural field, and/or
(C) historic treatment data relating to treatments conducted in the agricultural field in the past, wherein the data (A), (B), and/or (C) are provided before the step of determining a second ranking.

According to a further preferred embodiment of the present invention, determining a first ranking and a second ranking of treatment parameter can be additionally based on
(A) agricultural crop data comprising (aa) information about an agricultural crop species grown, sown, planned to be grown, or planned to be sown in the agricultural field, and/or (bb) information about the growth stage of such agricultural crop, and/or
(B) weather and/or geographical data relating to the location of the agricultural field, and/or
(C) historic treatment data relating to treatments conducted in the agricultural field in the past, wherein the data (A), (B), and/or (C) are provided before the step of determining a first ranking.

In the context of the present invention, the weather and/or geographic data are weather data and/or geographic data.

In the context of the present invention, weather data can be any data on weather, including but not limited to temperature, soil temperature, canopy temperature, humidity, precipitation, moisture, wind conditions, sunlight levels etc.

In the context of the present invention, geographic data can be any data on geography or topography, including GPS (Global Positioning System) data, elevation data, soil data etc.

In the context of the present invention, “genetic measurement data” can be any data relating to genetic information, including an identifier for the genetic information, or the genetic information as such, which has been preferably obtained through a measurement—for example using a sample—, or alternatively obtained from user input or from databases.

In the context of the present invention, historic treatment data can be preferably provided via a user interface and/or a data interface.

In the context of the present invention, the term “control file” refers to any binary file, data, signal, identifier, information, or application map which is preferably useful for controlling an agricultural equipment.

According to a preferred embodiment of the present invention, the computer-implemented method of the present invention further comprises the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic measurement data of the at least one organism.

According to a preferred embodiment of the present invention, the sample of the at least one organism is a real-world physical sample of the at least one organism. The sample can be taken from any medium or material containing the organism, preferably from the soil, from the straw, from the air, from water, from parts of a plant, from pollen, from seeds, from the organism as such (e.g. insects, arachnids, nematodes, mollusks), from eggs or different growth stages of the organism (e.g. eggs or larvae of insects, arachnids, nematodes, mollusks).

According to a further preferred embodiment of the present invention, the computer-implemented method of the present invention further comprises the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic and/or epigenetic information of the at least one organism, wherein the genetic analysis is based on at least one of the technologies selected from the group consisting of sequencing technologies—such as Sanger sequencing, next generation sequencing, pyrosequencing, nanopore sequencing, GenapSys sequencing, sequencing by ligation (SOLID sequencing), single-molecule real-time sequencing, Ion semiconductor (Ion Torrent sequencing) sequencing, sequencing by synthesis (Illumina), combinatorial probe anchor synthesis (cPAS-BGI/MGI)—, nanopore technology, microarray technology, graphene biosensor technology, PCR (polymerase chain reaction) technology, fast PCR technology, and other DNA/RNA amplification technologies such as isothermal amplification—such as LAMP (Loop mediated amplification), RPA (Recombinase Polymerase Amplification), Nucleic Acid Sequenced Based Amplification (NASBA) and Transcription Mediated Amplification (TMA)—, as well as epigenetic analysis such as DNA methylation, DNA-Protein interaction analysis, and Chromatin accessibility analysis.

According to a further preferred embodiment of the present invention, the computer-implemented method of the present invention further comprises the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic measurement data of the at least one organism, wherein the genetic analysis is based on selective genotyping or based on sequencing technologies such as nanopore technology, pyrosequencing technology and other sequencing or next-generation sequencing (NGS) technologies.

According to a further preferred embodiment of the present invention, the computer-implemented method of the present invention further comprises the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic information of the at least one organism, wherein the genetic analysis is based on at least one of the technologies selected from the group consisting of: Maxam-Gilbert sequencing, Chain-termination methods, large-scale sequencing and de novo sequencing, Shotgun sequencing, High-throughput sequencing methods, Long-read sequencing methods, Single molecule real time (SMRT) sequencing, Nanopore DNA sequencing, Shortread sequencing methods, Massively parallel signature sequencing (MPSS), Colony sequencing, pyrosequencing, Illumina (Solexa) sequencing, Combinatorial probe anchor synthesis (cPAS), SOLID sequencing, Ion Torrent semiconductor sequencing, DNA nanoball sequencing, Heliscope single molecule sequencing, Sequencing using Microfluidic Systems, Tunnelling currents DNA sequencing, Sequencing by hybridization, Sequencing with mass spectrometry, Microfluidic Sanger sequencing, Microscopy-based techniques, RNAP sequencing, In vitro virus high-throughput sequencing, LAMP (Loop mediated amplification), RPA (Recombinase Polymerase Amplification), NASBA (Nucleic Acid Sequenced Based Amplification), Transcription Mediated Amplification, as well as epigenetic analysis such as DNA methylation, DNA-Protein interaction analysis, Chromatin accessibility analysis.

According to a further preferred embodiment of the present invention, the computer-implemented method of the present invention further comprises the following step before (step 1) (110):
(step 0) (100) taking at least two samples of the at least one organism which existed or is existing or is expected to exist in the agricultural field, conducting a genetic analysis using the at least two samples of the at least one organism, and obtaining therefrom the genetic measurement data of the at least one organism, and wherein the at least two samples have been taken from at least two different locations within the agricultural field.

According to a further preferred embodiment of the present invention, the computer-implemented method of the present invention further comprises the following step before (step 1) (110):
(step 0) (100) taking at least two samples of the at least one organism which existed or is existing or is expected to exist in the agricultural field, conducting a genetic analysis using the at least two samples of the at least one organism, and obtaining therefrom the genetic measurement data of the at least one organism, and wherein the at least two samples have been taken from at least two different zones within the agricultural field.

According to a further preferred embodiment of the present invention, the computer-implemented method of the present invention further comprises the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic measurement data of the at least one organism, and wherein the samples have been taken from each of the zones within the agricultural field.

According to a further preferred embodiment of the present invention, the at least one organism is a harmful organism, preferably a harmful organism selected from the group consisting of: weeds, fungi, viruses, bacteria, insects, arachnids, nematodes, mollusks, birds, and rodents.

According to a further preferred embodiment of the present invention, the at least one organism is a beneficial organism, preferably a beneficial organism selected from the group consisting of: beneficial plants, fungi, viruses, bacteria, insects, arachnids, nematodes, mollusks, birds, rodents, and protozoa.

According to a further preferred embodiment of the present invention, the at least one organism is an agricultural crop species grown, sown, planned to be grown, or planned to be sown in the agricultural field.

In some cases, it may be not sufficient to only obtain the genetic measurement data of the harmful organism to determine the treatment parameters for a highly efficient treatment, especially if for example the agricultural crop plant has a different genetic property than expected (e.g. is an unexpected mutant or variant). In such cases, the treatment parameters for a highly efficient treatment can only be determined after the genetic measurement data of both the harmful organism and the agricultural crop plant have been obtained. Furthermore, to make the sample-taking (sampling) process more efficient, it is preferred to take a sample containing both a part of the harmful organism and a part of the agricultural crop plant, for example a leave of the agricultural crop plant partially infested with a specific fungal disease.

According to a further preferred embodiment of the present invention, in (step 1) (110) of the computer-implemented method, genetic measurement data of at least one harmful organism which existed or is existing or is expected to exist in the agricultural field, and genetic measurement data of at least one agricultural crop plant grown, sown, planned to be grown or sown in the agricultural field are provided.

According to a further preferred embodiment of the present invention, in (step 1) (110) of the computer-implemented method, genetic measurement data of at least one beneficial organism which existed or is existing or is expected to exist in the agricultural field, and genetic measurement data of at least one agricultural crop plant grown, sown, planned to be grown or sown in the agricultural field are provided.

According to a further preferred embodiment of the present invention, the genetic analysis of the at least one organism is conducted using a portable device operated in the agricultural field.

According to a further preferred embodiment of the present invention, the genetic analysis of the at least one organism is conducted in a facility outside the agricultural field.

According to a further preferred embodiment of the present invention, the timeframe between sample-taking (step 0) (100) and the provision of the genetic measurement data (step 1) (110) is from 1 seconds to 5 days, more preferably from 1 minute to 3 days, most preferably from 5 minutes to 1 day, particularly preferably from 10 minutes to 15 hours, particularly more preferably from 15 minutes to 10 hours, particularly from 20 minutes to 10 hours, for example from 30 minutes to 5 hours.

According to a further preferred embodiment of the present invention, the genetic measurement data of the at least one organism has been provided by a user interface and/or by a data interface.

According to a further preferred embodiment of the present invention, the highest ranked treatment parameter will be—preferably automatically—outputted as a control file for an agricultural equipment, preferably for controlling the agricultural equipment to treat an agricultural field.

According to a further preferred embodiment of the present invention, the present invention relates to a computer-implemented method for determining a ranking of at least two treatment parameters selected from the group consisting of:
a) at least one time window for a treatment in an agricultural field,
b) at least one method for a treatment in an agricultural field,
c) at least one product for a treatment in an agricultural field,
d) at least one dose rate for a treatment in an agricultural field, and
e) at least one treatment schedule for a treatment in an agricultural field comprising at least one method or product and a time window for applying the at least one method or product in the agricultural field,
comprising the following steps:
(step 1) (110) providing genetic measurement data (40) of at least one organism which existed or is existing or is expected to exist in the agricultural field,
(step 2) (120) providing treatment parameter data (42) for at least two treatment parameters capable of targeting the at least one organism,
(step 3) (130) based on the treatment parameter data (42), providing first level efficacy data (44) comprising efficacies (“first level efficacies”) of the at least two treatment parameters relating to the at least one organism on a first level of the taxonomic rank,
(step 4) (140) based on the treatment parameter data (42) and the first level efficacy data (44), determining a first ranking (46) of the at least two treatment parameters,
(step 5) (150) providing an efficacy adjustment model (50),
(step 6) (160) by modifying the first level efficacy data (44) based on the genetic measurement data (40) and the treatment parameter data (42) via the efficacy adjustment model (50), obtaining second level efficacy data (52) comprising efficacies (“second level efficacies”) of the at least two treatment parameters relating to the at least one organism on a second level of the taxonomic rank being below the first level of the taxonomic rank,
(step 7) (170) based on the treatment parameter data (42) and the second level efficacy data (52), determining a second ranking (54) of the at least two treatment parameters,
(step 8) (180) outputting the highest ranked treatment parameter as a control file usable for controlling an agricultural equipment, preferably for controlling the agricultural equipment to treat an agricultural field.

According to a further preferred embodiment of the present invention, at least the steps
(step 1) (110), (step 2) (120), (step 3) (130), (step 4) (140), (step 5) (150), (step 6) (160) and (step 7) (170)
are carried out in a real-time mode, i.e. preferably less than a minute, more preferably within 10 to 45 seconds, most preferably within 1 to 10 seconds, more preferably within 0.5 to 1 seconds, most preferably within 100 to 500 milliseconds, particularly within 10 to 100 milliseconds.

According to a further preferred embodiment of the present invention, at least the steps
(step 1) (110), (step 2) (120), (step 3) (130), (step 4) (140), (step 5) (150), (step 6) (160), (step 7) (170) and (step 8) (180)
are carried out in a real-time mode, i.e. preferably less than a minute, more preferably within 10 to 45 seconds, most preferably within 1 to 10 seconds, more preferably within 0.5 to 1 seconds, most preferably within 100 to 500 milliseconds, particularly within 10 to 100 milliseconds.

According to a further preferred embodiment of the present invention, at least one, preferably two, more preferably three, most preferably four, particularly preferably five, for example all of the steps
(step 1) (110), (step 2) (120), (step 3) (130), (step 4) (140), (step 5) (150), (step 6) (160) and (step 7) (170)
are carried out in a cloud or cloud server in the context of a distributed computing system.

According to a further preferred embodiment of the present invention, at least one, preferably two, more preferably three, most preferably four, particularly preferably five, for example all of the steps
(step 1) (110), (step 2) (120), (step 3) (130), (step 4) (140), (step 5) (150), (step 6) (160), (step 7) (170) and (step 8) (180)
are carried out in a cloud or cloud server in the context of a distributed computing system.

According to a further preferred embodiment of the present invention, preferably (step 5) (150) and (step 6) (160) are carried out in a cloud or cloud server in the context of a distributed computing system.

According to a further preferred embodiment of the present invention, the present invention also relates to a data processing system comprising means for carrying out the computer-implemented method of this invention.

According to a further preferred embodiment of the present invention, the present invention also relates to a computer program product comprising instructions which, when the program is executed by a computer, cause the computer to carry out the computer-implemented method of the invention

According to a further preferred embodiment of the present invention, the present invention also relates to a computer-readable storage medium comprising instructions which, when executed by a computer, cause the computer to carry out the computer-implemented method according to the invention.

According to a further preferred embodiment of the present invention, the present invention also relates to the use of the highest ranked treatment parameter determined by the computer-implemented method according to the invention for controlling an agricultural equipment.

According to a further preferred embodiment of the present invention, the present invention also relates to the use of the highest ranked treatment parameter determined by the computer-implemented method according to the invention for treating an agricultural field.

In the context of the present invention, the term “treatment parameter” is any parameter useful for a treatment in an agricultural field and is selected from the group consisting of:
a) at least one time window for a treatment in an agricultural field,
b) at least one method for a treatment in an agricultural field,
c) at least one product for a treatment in an agricultural field,
d) at least one dose rate for a treatment in an agricultural field, and
e) at least one treatment schedule for a treatment in an agricultural field comprising at least one method or product and a time window for applying the at least one method or product in the agricultural field.

According to a further preferred embodiment of the present invention, the treatment parameter is a time window for a treatment in an agricultural field.

According to a further preferred embodiment of the present invention, the treatment parameter is a method for a treatment in an agricultural field.

According to a further preferred embodiment of the present invention, the treatment parameter is a product for a treatment in an agricultural field.

According to a further preferred embodiment of the present invention, the treatment parameter is a dose rate for a treatment in an agricultural field.

According to a further preferred embodiment of the present invention, the treatment parameter is a treatment schedule for a treatment in an agricultural field comprising at least one method or product and a time window for applying the at least one method or product in the agricultural field.

In the context of the present invention, the term “treatment parameter data” is any data—including identifiers, proxy data etc.—relating to treatment parameter.

According to a further preferred embodiment of the present invention, the treatment parameter data are time window data relating to a time window for a treatment in an agricultural field.

According to a further preferred embodiment of the present invention, the treatment parameter data are method data relating to a method for a treatment in an agricultural field.

According to a further preferred embodiment of the present invention, the treatment parameter data are product data relating to a product for a treatment in an agricultural field. More preferably the treatment parameter data are product data such as
product usage data,
product registration data,
product sustainability data,
product ingredient or composition data,
data on physical, chemical, biological properties of the product,
data on toxicity, hazards or safety of the product,
data on organisms which the product is capable of targeting,
data on crops, crop species, crop varieties, crop traits, crop genetic variants, crop growth stages for which the product is applicable or appropriate to use.

According to a further preferred embodiment of the present invention, the treatment parameter data are dose rate data relating to a dose rate for a treatment in an agricultural field.

According to a further preferred embodiment of the present invention, the treatment parameter are treatment schedule data relating to a treatment schedule for a treatment in an agricultural field comprising at least one method or product and a time window for applying the at least one method or product in the agricultural field.

In the context of the present invention, the term “modify” means “change” and/or “validate”. “validate” means that data or objects are confirmed and/or verified as being correct and remain unchanged.

In the context of the present invention, the term “targeting” means
controlling or diminishing or removing in case of the organism being a harmful organism, and
controlling or protecting or “transferring into safer areas” in case of the organism being a beneficial organism or a crop plant.

In the context of the present invention, the term “organism” is understood to be any kind of individual entities having the properties of life, including but not limited to plants, crop plants, weeds, fungi, viruses, bacteria, insects, arachnids, nematodes, mollusks, birds, rodents, other animals, protozoa, protists, and archaea.

In the context of the present invention, the term “harmful organism” is understood to be any organism which has a negative impact to the growth or to the health of the agricultural crop plant.

In the context of the present invention, the term “beneficial organism” is understood to be any organism which does not have a negative impact to the growth or to the health of the agricultural crop plant. The terms “beneficial organism” and “benign organism” are used synonymously.

In the context of the present invention, the term “genetic information” is understood to be any kind of information on the genetic properties of an organism, including but not limited to DNA sequence, RNA sequence, parts of DNA and/or RNA sequences, molecular structure of DNA and/or RNA, epigenetic information (e.g. methylation of DNA parts), information on gene mutations, information on gene copy number variation, information on overexpression of a gene, information on expression level of a gene, information on gene shifting, information on the ratio between wild type and mutants, information on the ratio between different mutants, information on the ratio between mutants and other variants (e.g. epigenetic variants), information on the ratio of different variants (e.g. epigenetic variants), information on a type of plant disease (e.g. Septoria, yellow rust, Asian soybean rust) or other diseases. In the context of the present invention, the term “genetic information” also includes the information that certain wild types, mutants, or variants (e.g. epigenetic variants) or DNA/RNA sequences, or parts of the DNA/RNA sequences, or specific epigenetic information are absent. In the context of the present invention, the term “genetic information” also includes the information that specific genetic information is absent (e.g. that the information that a specific type of Septoria is absent is also a genetic information). In a preferred embodiment of the present invention, genetic information” is at least one of the following information: DNA sequence, RNA sequence, parts of DNA and/or RNA sequences, molecular structure of DNA and/or RNA, epigenetic information (e.g. methylation of DNA parts), information on gene mutations, information on gene copy number variation, information on overexpression of a gene, information on expression level of a gene, information on gene shifting, information on the ratio between wild type and mutants, information on the ratio between different mutants, information on the ratio between mutants and other variants (e.g. epigenetic variants), information on the ratio of different variants (e.g. epigenetic variants), information on a type of plant disease (e.g. Septoria, yellow rust, Asian soybean rust) or other diseases. In another preferred embodiment of the present invention, genetic information” is at least one of the following information: DNA sequence, RNA sequence, molecular structure of DNA and/or RNA, parts of DNA and/or RNA sequences, epigenetic information (e.g. methylation of DNA parts). In another preferred embodiment of the present invention, genetic information” is at least one of the following information: DNA sequence, RNA sequence. In another preferred embodiment of the present invention, genetic information” is at least one of the following information: information on gene mutations, information on gene copy number variation, information on overexpression of a gene, information on expression level of a gene, information on gene shifting, information on the ratio between wild type and mutants, information on the ratio between different mutants, information on the ratio between mutants and other variants (e.g. epigenetic variants), information on the ratio of different variants (e.g. epigenetic variants), information on a type of plant disease (e.g. Septoria, yellow rust, Asian soybean rust) or other diseases. In another preferred embodiment of the present invention, genetic information” is at least one of the following information: information on gene mutations, information on gene copy number variation, information on overexpression of a gene, information on expression level of a gene, information on gene shifting. In another preferred embodiment of the present invention, genetic information” is at least one of the following information: information on the ratio between wild type and mutants, information on the ratio between different mutants, information on the ratio between mutants and other variants (e.g. epigenetic variants), information on the ratio of different variants (e.g. epigenetic variants).

In another preferred embodiment of the present invention, the genetic information is the information on the resistance of an organism against certain crop protection products.

In the context of the present invention, the term “treatment” is understood to be any kind of treatment possible on an agricultural field, including but not limited to seeding, fertilization, crop protection, growth regulation, harvesting, adding or removing of organisms—particularly crop plants—, as well as soil treatment, soil nutrient management, soil nitrogen management, tilling, ploughing, irrigation. In a preferred embodiment of the present invention, treatment is one of the following activities: seeding, fertilization, crop protection, growth regulation, harvesting, adding or removing of organisms—particularly crop plants—, as well as soil treatment, soil nutrient management, soil nitrogen management, tilling, ploughing, irrigation. In another preferred embodiment of the present invention, treatment is seeding. In another preferred embodiment of the present invention, treatment is fertilization. In another preferred embodiment of the present invention, treatment is crop protection. In another preferred embodiment of the present invention, treatment is growth regulation. In another preferred embodiment of the present invention, treatment is harvesting. In another preferred embodiment of the present invention, treatment is adding or removing of organisms—particularly crop plants.

In the context of the present invention, the term “agricultural field” is understood to be any area in which organisms, particularly crop plants, are produced, grown, sown, and/or planned to be produced, grown or sown. The term “agricultural field” also includes horticultural fields, silvicultural fields and fields for the production and/or growth of aquatic organisms.

In the context of the present invention, the term “efficacy” is understood to be as the level or degree of reduction or removal of a target organism (such as weed, fungi, or insect pest). 100% efficacy would for example mean that approx. 100% of the target organisms can be removed using a certain treatment parameter. 50% efficacy would for example mean that approx. 50% of the target organisms can be removed using a certain treatment parameter. 0% efficacy would for example mean that approx. 0% of the target organisms can be removed using a certain treatment parameter.

In the context of the present invention, the term “taxonomic rank” is understood to be a relative level of a group of organisms in a taxonomic hierarchy. Taxonomic ranks for animals are e.g. kingdom, phylum, class, order, family, genus, species, subspecies. Taxonomic ranks for plants are e.g. kingdom, phylum, class, order, family, genus, species, subspecies, variety. If the first level of the taxonomic rank is for example a genus, the second level of the taxonomic rank being below the first level of the taxonomic rank is for example a species, a subspecies or a variety. If the first level of the taxonomic rank is for example a species, the second level of the taxonomic rank being below the first level of the taxonomic rank is for example a subspecies or a variety. If the first level of the taxonomic rank is for example a subspecies, the second level of the taxonomic rank being below the first level of the taxonomic rank is for example a variety.

In the context of the present invention, a “method for a treatment” includes but is not limited to
mechanical methods—e.g. mechanical weed removal by machinery such as robots, which for example cuts out the weed,
physical methods—e.g. weed removal by optical light such as laser,
chemical methods—e.g. weed removal by spraying a herbicide, or e.g. attracting beneficial insects to another area outside the agricultural field using chemical attractants,
biological methods—e.g. weed removal by applying a microorganism used as bioherbicide, or e.g. attracting beneficial insects to another area outside the agricultural field by placing other organisms (which serves as food for the beneficial insects) into this another area.

In the context of the present invention, the term “product” is understood to be any object or material useful for the treatment. In the context of the present invention, the term “product” includes but is not limited to:
chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof.
biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof.
fertilizer and nutrient,
seed and seedling,
water,
further non-chemical products such as mechanical/physical/optical weed or fungi or insect removal equipment, including weed or fungi or insect removal machines, robots or drones,
any combination thereof.

In the context of the present invention, the term “product” also includes a combination of different products.

In a preferred embodiment of the present invention, product is at least one chemical product selected from: fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor; or any combination thereof.

In another preferred embodiment of the present invention, product is at least one biological product selected from: microorganisms useful as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor; or any combination thereof.

In another preferred embodiment of the present invention, product is fertilizer and/or nutrient.

In another preferred embodiment of the present invention, product is seed and/or seedling.

In the context of the present invention, the term “dose rate” is understood as amount of product to be applied per area, for example expressed as liter per hectare (L/ha).

In the context of the present invention, the time window for a treatment can preferably range from 10 days to 1 hour, more preferably from 7 days to 3 hours, most preferably from 5 days to 5 hours, particularly preferably from 3 days to 8 hours, particularly more preferably from 2 days to 12 hours, particularly from 36 hours to 16 hours, for example from 28 hours to 20 hours.

In a preferred embodiment of the present invention, “an organism expected to exist in an agricultural field” is an organism which is expected to exist in an agricultural field according to corresponding predictions or forecasts related to such organism in this agricultural field or in its surroundings or its region or its country—such as predictions on the presence of plant diseases, insect pests or weeds—or according to corresponding historic experience related to such organism in this agricultural field or in its surroundings or its region or its country, or according to corresponding historic experience related to the growth of a specific agricultural crop plant. The predictions or forecasts related to such organism can be based on corresponding computer models.

In a preferred embodiment of the present invention, the efficacy adjustment model is a data-driven model which is parametrized according to a historic dataset.

In a preferred embodiment of the present invention, the efficacy adjustment model is a machine learning model such as a decision tree, a computer-implemented neural network or an artificial neural network or any combination thereof. For training the machine learning model, training data is split into two parts, one for training and one for testing, e.g., 90% of the data for training and 10% for testing. When training and testing the machine learning model, a mean absolute error may be used as evaluation metric.

In a preferred embodiment of the present invention, the efficacy adjustment model is process model in which certain functions of and/or dependences between parameters are provided by a user. These functions and/or dependences may be simple functions and may be based on past observations.

These and other aspects of the invention will be apparent from and elucidated further with reference to the embodiments described by way of examples in the following description and with reference to the accompanying drawings, in which

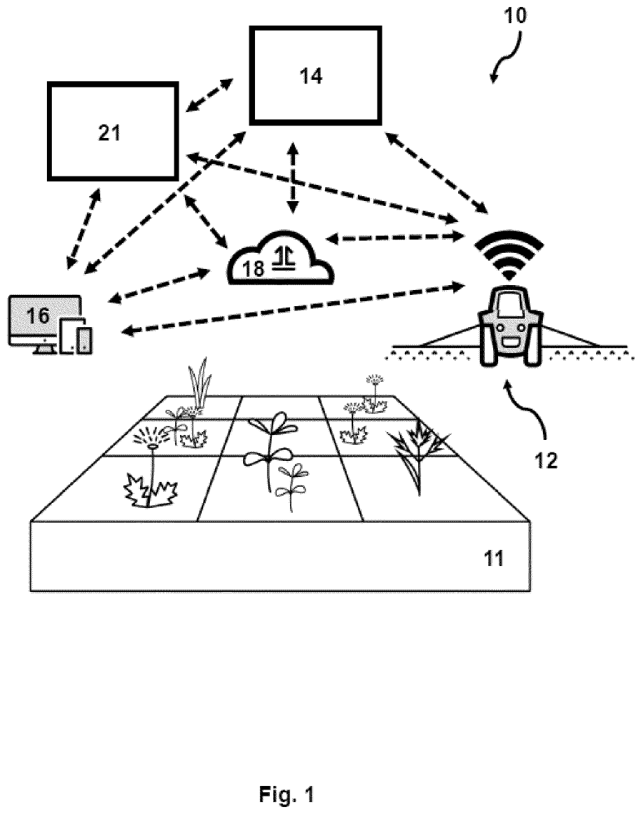

FIG. 1 illustrates one example of a distributed computing system suitable for controlling or monitoring a treatment on an agricultural field;

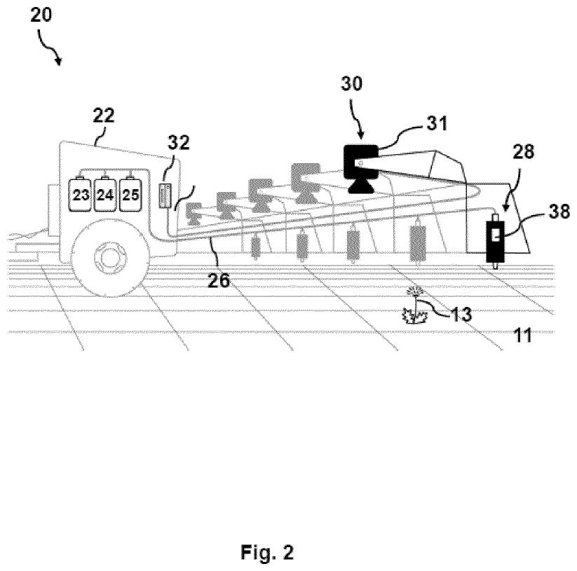

FIG. 2 illustrates one example of an agricultural treatment device for applying a product to a field;

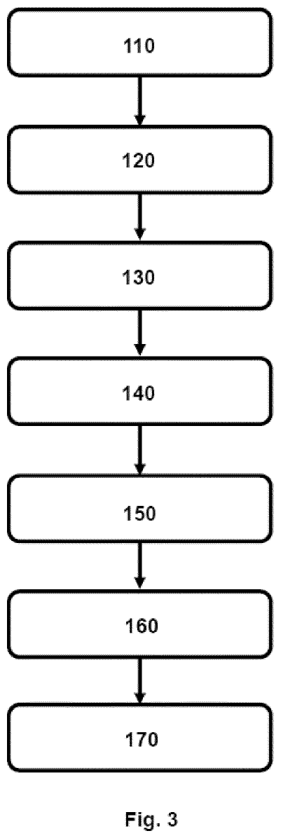

FIG. 3 illustrates a flow diagram of one example method for determining a ranking of at least two treatment parameters;

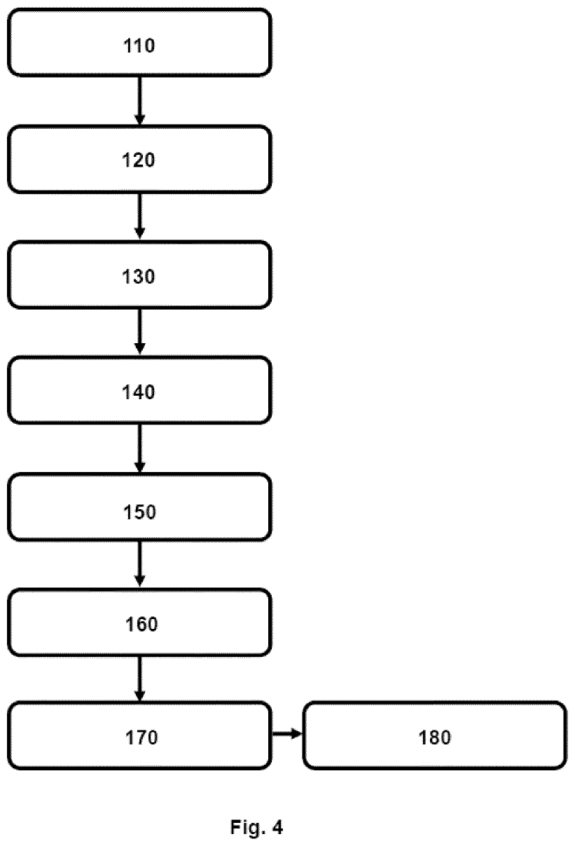

FIG. 4 illustrates a flow diagram of one example method for determining a ranking of at least two treatment parameters with the output as control file for an agricultural equipment;

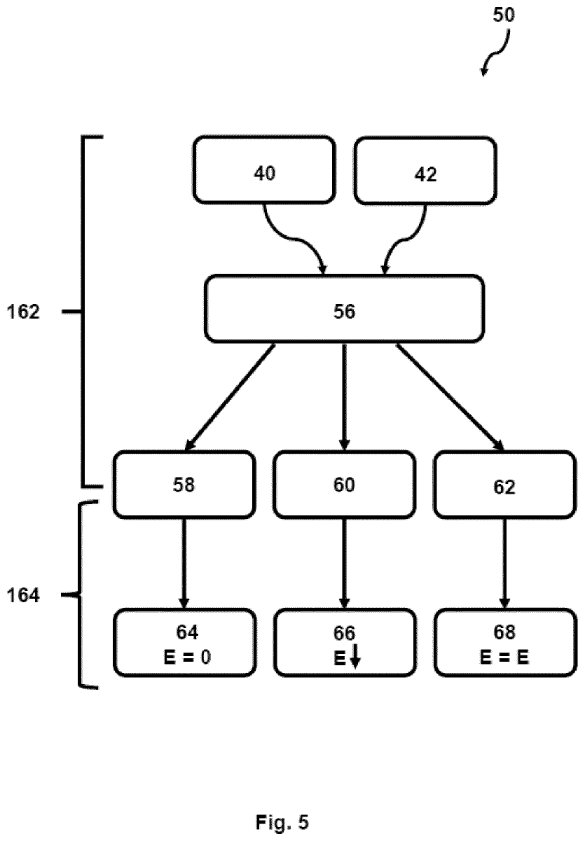

FIG. 5 illustrates a flow diagram of one example method for showing the operation of the efficacy adjustment model;

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF THE DRAWINGS

FIG. 1 illustrates one example of a distributed computing system 10 for controlling or monitoring a treatment on an agricultural field using the agricultural treatment device 20.

The distributed system 10 is configured for treatment of a field 11 cultivating crops. The field 11 may be any plant or crop cultivation area at a geo-referenced location. As indicated in FIG. 1 by interlines, the field 11 may optionally be divided into two or more sub-areas illustrating zone-specific or location specific specificity. The system 10 may include a distributed computing system with remote computing resources 12, 14, 16, 18, 20. The system 10 may include smart machinery 10 configured to treat the field, such as one or more crop protection treatment device(s) 20 or one or more harvesting device(s), a preparation system 14 configured to control or monitor crop protection treatment, a client device 16 configured to display output data to a user or to collect input data from a user, a data distribution system 18—for example a cloud—configured to send or receive data packets and one or more production management system(s) 20 configured to monitor processing of the agricultural product harvested. The field 11 may be treated by use of a crop protection product such as an herbicide, a fungicide, an insecticide or a nematicide.

For a more integrated controlling or monitoring, the system 10 includes a preparation system 14 for generating the treatment control data. The treatment control data may be a data set in a machine-readable format including
at least one field identifier indicating the location of the field 11 and/or field attributes including crop data such as crop type or crop growth stage;
at least one treatment product identifier indicating a treatment product to be applied on the field 11, such as an herbicide, a fungicide, an insecticide or a nematicide;
at least one treatment operation parameter indicating an amount of treatment product to be applied to the field 11; and
at least one treatment time or time window indicating a time for conducting the treatment on the field.

The treatment control data may be provided to the crop protection treatment device 20 prior to or during the treatment. The treatment device 20 may control the application of the treatment product, such as an herbicide, a fungicide, an insecticide or a nematicide, to the field 11 based on the treatment operation parameter and the treatment time or time range. The treatment control data may be spatially resolved in one or more data points by relating the data point to a location or sub-area of the field 11. The treatment control data may include one treatment product identifier associated with the treatment product or product mix to be applied to the field 11. The treatment control data may include more than one treatment product identifier indicating a spatially resolved treatment product map with different treatment products or product mixes to be applied in different locations of the field 11. The treatment control data may include one treatment operation parameter associated with an amount or dosage of treatment product to be applied to the field 11. The treatment control data may include more than one treatment operation parameter indicating a spatially resolved treatment map with different amounts of treatment products to be applied in different locations of the field 11. The treatment control data may include one treatment time or time range associated with the time for conducting the treatment on the field 11. The treatment control data may include more than one treatment time or time window indicating the spatially resolved timing map with different treatment times or time ranges for treating the field 11 in different locations.

The preparation system 14 may include a database configured to store efficacy adjustment models. The stored efficacy adjustment model may be used to generate second level efficacy data and to determine a ranking of treatment parameters such as products for treating the plants cultivated on the field 11. The preparation system 14 may include an interface configured to receive genetic measurement data from genetic analysis conducted either during or prior to treatment on the field 11. The preparation system 14 may for instance include an interface configured to receive treatment parameter data such as product data as well as first level efficacy data. The preparation system 14 may include an interface configured to send at least one treatment control data (relating to the highest ranked treatment parameter) to the treatment device 20, the client device 16, the data distribution system 18 or the processing system 21. Similar inter-faces may be included in the treatment device 20, the client device 16, the data distribution system 18 or the processing system 21 to send or receive respective data packages. In particular, when data is monitored, collected and/or recorded by any treatment device 20, such data may be distributed to one or more of, or to every computing system 14, 16, 18, 20 of the distributed computing system 10.

FIG. 2 illustrates one example of a crop protection treatment device 20 for applying a crop protection product (such as an herbicide, a fungicide, an insecticide or a nematicide) to a field. It is noted that FIG. 2 is merely schematic illustrating main components. The agricultural treatment device 20 may comprise more, less, or different components than shown.

The agricultural treatment device 20 may be part of the machinery 10 (as shown in FIG. 1) and configured to apply the crop protection product on the field 11 or on one or more subareas thereof. The release elements 28 may be configured to apply crop protection product to the field 11. In at least some embodiments, the agricultural treatment device 20 may comprise a boom with multiple release elements 28 arranged along the boom. The release elements 28 may be fixed or may be attached movably along the boom in regular or irregular intervals. Each release element 28 may be arranged together with one or more, preferably separately, controllable valves 38 to regulate treatment product release to the field 11.

One or more tank(s) 23, 24, 25 may be placed in a housing 22 and may be in communication with the release elements 28 through one or more connections 28, which distribute the one or more crop protection products (such as an herbicide, a fungicide, an insecticide or a nematicide). Each tank 23, 24, 25 may further comprise a controllable valve to regulate release from the tank 23, 24, 25 to connections 26.

The tank valves and/or the release elements 28 may be communicatively coupled to a control system 32. In the embodiment shown in FIG. 2, the control system 32 is located in a main housing 22 and wired to the respective components. In another embodiment the tank valves or the valves of the release elements 28 may be wirelessly connected to the control system 32. In yet another embodiment more than one control system 32 may be distributed in the housing 22 and communicatively coupled to the tank valves or the valves of the release elements 28.

The control system 32 may be configured to control the tank valves or the valves of the release elements 28 based on the treatment control data. The treatment control data may be a control file or control protocol based on which the agricultural treatment device 20 is controlled during treatment. The control system 32 may comprise multiple electronic modules with instructions, which when executed control the treatment, in particular by controlling the tank release or the release elements 28. One module for instance may be configured to collect data during application on the field 11, e.g. location data. A further module may be configured to receive the control file with the treatment control data. A further module may be configured to derive a control signal from the location data and the control file. Yet further module(s) may be configured to control the tank 23, 24, 25 release and/or release elements 28 based on such derived control signal. Yet further module(s) may be configured to store control and/or monitoring data of the treatment device 20, such as as-applied maps, during treatment execution on the field 11. Yet further module(s) may be configured to provide control and/or monitoring data of the treatment device 20, such as as-applied maps, collected during treatment execution on the field 11 to e.g. the client device 16, the data distribution system 18 or the processing system 21 of FIG. 1.

FIG. 3 illustrates a flow diagram of one example method for determining a ranking of at least two treatment parameters.

In (step 1) (110), genetic measurement data (40) for the weed species W1 is provided, which is indicative of the existence of a specific mutant M1 of W1. In (step 2) (120), product data (42) for two herbicides, herbicide H1 and herbicide H2, capable of targeting W1, are provided. In (step 3) (130), based on the product data (42), first level efficacy data (44) comprising efficacies (“first level efficacies”) of herbicides H1 and H2 relating to W1 on species level are provided. In (step 4) (140), based on the product data (42) and the first level efficacy data (44), a first ranking (46) of the two herbicides H1 and H2 is determined, e.g. H1 has first level efficacy of 99% and H2 has first level efficacy of 90%, so that H1 is ranked higher than H2. In (step 5) (150), an efficacy adjustment model is provided. In (step 6) (160), the first level efficacy data (44) are modified based on the genetic measurement data (40) and the product data (42) via the efficacy adjustment model (50), obtaining second level efficacy data (52) comprising efficacies (“second level efficacies”) of the two herbicides relating to W1 on the level of mutant M1, e.g. first level efficacy for H1 has been reduced from 99% to 0% due to a target-site resistance of mutant M1 against H1, the second level efficacy for H2 remains unchanged at 90% because there is no target-site and no non-target-site resistance of mutant M1 against H2. In (step 7) (170), based on the treatment parameter data (42) and the second level efficacy data (52) being 0% for H1 and 90% for H2, a second ranking (54) of the two herbicides is determined, with the result that H2 is now ranked higher than H1.

For example, the weed species W1 is Amaranthus palmeri, and the mutant M1 is a mutation on amino acid Pro 106.

FIG. 4 illustrates a flow diagram of one example method for determining a ranking of at least two treatment parameters with the output as control file for an agricultural equipment.

The steps (step 1) (110) to (step 7) (170) are the same as described above for FIG. 3. Additionally, in the final step (step 8) (180), the highest ranked treatment parameter, which is H2 (90% second level efficacy compared to 0% second level efficacy for H1 relating to mutant M1), is automatically outputted as control file for controlling an agricultural equipment, e.g. a sprayer.

FIG. 5 illustrates a flow diagram of one example method for showing the operation of the efficacy adjustment model. In (step 6a) (162), based on the genetic measurement data (40) and the treatment parameter data (42), the type of genetics-specific response (56) of the at least one organism is assigned via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response.

In (step 6b) (164) the following operations are conducted:
(64): In case of type 1 response (58), the first level efficacy data (44) are modified via the efficacy adjustment model (50) in a way that first level efficacies (abbreviated as “E”) are set to zero;
(66): In case of type 2 response (60), the first level efficacy data (44) are modified via the efficacy adjustment model (50) in a way that that first level efficacies (abbreviated as “E”) are reduced but not set to zero,
(68): In case of type 3 response (62), the first level efficacy data (44) are modified via the efficacy adjustment model (50) in a way that these data (abbreviated as “E”) are validated and/or remain unchanged.

### Example

In an example of the present invention, first, in (step 1) genetic measurement data (40) of the weed Eleusine indica (a weed which is existing in the agricultural field) has been provided. Then, in (step 2), herbicide data (42) for two specific herbicide products—first herbicide product (Her1) being glyphosate solo and the second herbicide product (Her2) being a 3:2 mixture of glyphosate and Clethodim—are provided. In (step 3) and (step 4), based on the corresponding herbicide data (42), first level efficacies of (Her1) and (Her2) are provided, wherein (Her1) is ranked higher than (Her2) at this stage. In (step 5), the efficacy adjustment model (50) is provided. In (step 6), the first level efficacy data (44) are modified via the efficacy adjustment model (50) based on the genetic measurement data (40), which indicates the existence of a specific glyphosate-resistant mutation of the weed Eleusine indica in this field, and based on the herbicide data (42), thus obtaining second level efficacy data (52) comprising efficacies of the two herbicide products (Her1) and (Her2) relating to this glyphosate-resistant mutation. In (step 7), based on the herbicide data (42) and the second level efficacy data (52), a second ranking (54) of the two herbicide products (Her1) and (Her2) is now determined, wherein (Her2) is now ranked higher than (Her1). In (step 8), the highest ranked herbicide product (Her2) is outputted as a control file usable for controlling an agricultural equipment.

1. A computer-implemented method for generating a control file usable for controlling an agricultural equipment based on at least one treatment parameter selected from the group consisting of:
a) at least one time window for a treatment in an agricultural field,
b) at least one method for a treatment in an agricultural field,
c) at least one product for a treatment in an agricultural field,
d) at least one dose rate for a treatment in an agricultural field, and
e) at least one treatment schedule for a treatment in an agricultural field comprising at least one method or product and a time window for applying the at least one method or product in the agricultural field,
wherein the method comprises the following steps:
(step 1) (110) providing genetic measurement data (40) of at least one organism which existed or is existing or is expected to exist in the agricultural field,
(step 2) (120) providing treatment parameter data (42) for at least two treatment parameters capable of targeting the at least one organism,
(step 3) (130) based on the treatment parameter data (42), providing first level efficacy data (44) comprising efficacies (“first level efficacies”) of the at least two treatment parameters relating to the at least one organism on a first level of the taxonomic rank,
(step 4) (140) based on the treatment parameter data (42) and the first level efficacy data (44), determining a first ranking (46) of the at least two treatment parameters,
(step 5) (150) providing an efficacy adjustment model (50),
(step 6) (160) by modifying the first level efficacy data (44) based on the genetic measurement data (40) and the treatment parameter data (42) via the efficacy adjustment model (50), obtaining second level efficacy data (52) comprising efficacies (“second level efficacies”) of the at least two treatment parameters relating to the at least one organism on a second level of the taxonomic rank being below the first level of the taxonomic rank,
(step 7) (170) based on the treatment parameter data (42) and the second level efficacy data (52), determining a second ranking (54) of the at least two treatment parameters, and
(step 8) (180) outputting the highest ranked or user-selected treatment parameter as a control file usable for controlling an agricultural equipment.

2. The computer-implemented method according to claim 1, wherein the obtaining of second level efficacy data (52) comprises the following steps:
(step 6a) (162) based on the genetic measurement data (40) and the treatment parameter data (42), determining the type of genetics-specific response (56) of the at least one organism via the efficacy adjustment model (50),
(step 6b) (164) based on the type of genetics-specific response (56), modifying the first level efficacy data (44) via the efficacy adjustment model (50),
(step 6c) (166) outputting the modified first level efficacy data as second level efficacy data (52).

3. The computer-implemented method according to claim 1, wherein the obtaining of second level efficacy data (52) comprises the following steps:
(step 6a) (162) based on the genetic measurement data (40) and the treatment parameter data (42), assigning the type of genetics-specific response (56) of the at least one organism via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response,
(step 6b) (164) wherein in case of type 1 response (58), the first level efficacy data (44) are modified via the efficacy adjustment model (50) in a way that first level efficacies are reduced,
wherein in case of type 2 response (60), the first level efficacy data (44) are modified via the efficacy adjustment model (50) in a way that that first level efficacies are reduced but reduced in a lower level compared to the case of type 1 response (58),
wherein in case of type 3 response (62), the first level efficacy data (44) are modified via the efficacy adjustment model (50) in a way that these data are validated and/or remain unchanged,
(step 6c) (166) outputting the modified first level efficacy data as second level efficacy data (52).

4. The computer-implemented method according to claim 1, wherein the obtaining of second level efficacy data comprises the following steps:
(step 6a) (162) based on the genetic measurement data (40) and the treatment parameter data (42), assigning the type of genetics-specific response (56) of the at least one organism via the efficacy adjustment model (50) to one of the following types:
a) type 1 response (58): target-site resistance (TSR),
b) type 2 response (60): non-target-site resistance (NTSR),
c) type 3 response (62): no relevant genetics-specific response,
(step 6b) (164) wherein in case of type 1 response (58), the first level efficacy data (44) are modified via the efficacy adjustment model (50) in a way that first level efficacies are set to zero,
wherein in case of type 2 response (60), the first level efficacy data (44) are modified via the efficacy adjustment model (50) in a way that that first level efficacies are reduced but not set to zero,
wherein in case of type 3 response (62), the first level efficacy data (44) are modified via the efficacy adjustment model (50) in a way that these data are validated and/or remain unchanged,
(step 6c) (166) outputting the modified first level efficacy data as second level efficacy data (52).

5. The computer-implemented method according to claim 1, further comprising the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic measurement data (40) of the at least one organism.

6. The computer-implemented method according to claim 1, further comprising the following step before (step 1) (110):
(step 0) (100) taking at least one sample of the at least one organism which existed or is existing or is expected to exist in the agricultural field, conducting a genetic analysis using the at least one sample of the at least one organism, and obtaining therefrom the genetic and/or epigenetic information of the at least one organism, wherein the genetic analysis is based on at least one of the technologies selected from the group consisting of sequencing technologies—such as Sanger sequencing, next generation sequencing, pyrosequencing, nanopore sequencing, GenapSys sequencing, sequencing by ligation (SOLID sequencing), single-molecule real-time sequencing, Ion semiconductor (Ion Torrent sequencing) sequencing, sequencing by synthesis (Illumina), combinatorial probe anchor synthesis (cPAS-BGI/MGI)—, nanopore technology, microarray technology, graphene biosensor technology, PCR (polymerase chain reaction) technology, fast PCR technology, and other DNA/RNA amplification technologies such as isothermal amplification—such as LAMP (Loop mediated amplification), RPA (Recombinase Polymerase Amplification), Nucleic Acid Sequenced Based Amplification (NASBA) and Transcription Mediated Amplification (TMA)—, as well as epigenetic analysis such as DNA methylation, DNA-Protein interaction analysis, and Chromatin accessibility analysis.

7. The computer-implemented method according to claim 1, wherein timeframe between sample-taking and the provision of the genetic measurement data (40) is from 1 seconds to 5 days.

8. The computer-implemented method according to claim 1, wherein the at least one organism is a harmful organism selected from the group consisting of: weeds, fungi, viruses, bacteria, insects, arachnids, nematodes, mollusks, birds, and rodents.

9. The computer-implemented method according to claim 1, wherein the at least one organism is a beneficial organism selected from the group consisting of: beneficial plants, fungi, viruses, bacteria, insects, arachnids, nematodes, mollusks, birds, rodents, and protozoa.

10. The computer-implemented method according to claim 1, wherein the at least one organism is an agricultural crop species grown, sown, planned to be grown, or planned to be sown in the agricultural field.

11. The computer-implemented method according to claim 1, wherein the highest ranked treatment parameter will be outputted as a control file for an agricultural equipment.

12. A data processing system comprising means for carrying out the computer-implemented method according to claim 1.

13. A computer program product comprising instructions which, when the program is executed by a computer, cause the computer to carry out the computer-implemented method according to claim 1.

14. A computer-readable storage medium comprising instructions which, when executed by a computer, cause the computer to carry out the computer-implemented method according to claim 1.

15. Use of the highest ranked treatment parameter determined by the computer-implemented method according to claim 1 for controlling an agricultural equipment.
